(19) United States
(12) Patent Application Publication
(10) Pub. No.: US 2010/0049156 A1
(43) Pub. Date: Feb. 25, 2010

(54) Non-collapsible and non-foldable container for lyophilization of a product

(75) Inventors: Dieter Dickhorner, Hagen (DE); Roland Reschke, Iserlohn (DE); Edgar Scheel, Hagen (DE); Dirk Reinert, Iserlohn (DE)

Correspondence Address: KNOBBE MARTENS OLSON & BEAR LLP, 2040 MAIN STREET, FOURTEENTH FLOOR, IRVINE, CA, 92614, US

(73) Assignees: DRK-BLUTSPENDEDIENST WEST GGMBH, Hagen (DE); HEINZ MEISE GMBH, Schalksmuhle (DE)

(21) Appl. No.: 12/544,152

(22) Filed: Aug. 19, 2009

(30) Foreign Application Priority Data
Aug. 19, 2008 (EP) 08162584.0

(51) Int. Cl. A61J 1/14; B65D 43/02; B65B 55/02

(52) U.S. Cl. 604/403; 220/315; 53/425

(57) ABSTRACT

The present invention refers to a non-collapsible and non-foldable container for lyophilization of a product, said container comprising:
a) a plastic tray comprising a bottom wall, a continuous peripheral side wall defining an opening, and a continuous circumferential rim which is outwardly bulged;
b) a top wall for completely covering said opening, which top wall is comprising a membrane which membrane is vapour-permeable and provides a bacterial barrier;
c) a removable impermeable snap-on lid for completely covering said top wall and said membrane.
   The container of the present invention is used for lyophilization of products and is easy to handle and provides a suitable shape for heat transfer during the lyophilization process. Further, the inventive container provides means for easy handling of opening and closing the membrane area before starting the lyophilization process, and also provides means for easy and reliable sealing after the lyophilization process, thereby protecting the membrane.

### CROSS-REFERENCE TO RELATED APPLICATIONS

This application claims the benefit of European Patent Application Number 08 162 584.0 filed on Aug. 19, 2008, the disclosures of which are hereby expressly incorporated by reference in their entirety and are hereby expressly made a portion of this application.

### BACKGROUND OF THE INVENTION

1. Field of the Invention

The present invention refers to a non-collapsible and non-foldable container for lyophilization of a product comprising a plastic tray, wherein the top wall comprises a vapour-permeable membrane which also provides a bacterial barrier, and an improved cover for protecting the membrane, the container comprising further means for protecting the membrane.

2. Description of the Related Art

The present invention in its simplest form is a container for freeze-drying and storing a product for example a biological material or a pharmaceutical material. In its more expanded form it serves to collect, process, freeze-dry, store, reconstitute and utilize biological and/or pharmaceutical material solutions preferably under sterile conditions.

Lyophilization is used to increase the shelf life of products for example biological or pharmaceutical solutions like blood or plasma by freezing the solution and then removing the solvent (usually water) by applying high vacuum. The rate of lyophilization is dependent on the vapour pressure of the drying mass, which in turns depends on the heat transferred by conduction from the shelf of the lyophilizer to the top of the frozen mass where evaporation occurs. The dehydrated frozen mass, or cake, is then stored until it is reconstituted by adding a solvent and then used as intended.

In order to lyophilize compositions for transfusion purposes a solution is introduced into glass bottles or vials under sterile conditions. Then a stopper is set on top of the container in the lyophilisation position allowing water vapour to escape. Then the bottles or vials are cooled to below −30° C. and frozen. After freeze-drying the bottles or vials are closed. The containers used for lyophilization according to the prior art have the drawback that they are heavy and difficult to handle in case glass vials are concerned. A further disadvantage is that even if the stopper is closing the opening of the glass bottle or vial, without additional sealing the opening may be considered open in the sense of being accessible for germs. This, however, makes necessary sterile conditions for any handling.

For easier handling plastic bags or plastic containers have been introduced for freeze-drying biological products such as plasma.

The U.S. Pat. No. 4,973,327 discloses a lyophilization bag in which a fluid, such as blood, may be introduced, lyophilized without collapsing the bag, stored, reconstituted and distributed from the bag without intermediate transfer of the useful contents from the bag.

The U.S. Pat. No. 5,257,983 discloses a container with its flexible peripheral walls reinforced with rigid structures to prevent its inward collapse and a bottom wall made of a rigid material.

The U.S. Pat. No. 5,309,649 discloses a container for freeze drying materials under sterile conditions, wherein the sides of the container consist at least partly of a hydrophobic, porous, germ-impermeable, water vapour-permeable membrane. The document discloses two forms of the container: a bag and a rigid rectangular tray both covered with the membrane. The bag described by U.S. Pat. No. 5,309,649 is open along one entire side to allow product introduction after which the open side of the bag is heat-sealed. Further, the bag is made with two layers, a floor and a roof, with the roof incorporating a hydrophobic membrane. Neither have sidewalls. U.S. Pat. No. 5,309,649 also illustrates a tray covered with a hydrophobic membrane, described as a tray which consists of liquid-impermeable synthetic resin.

The document U.S. Pat. No. 6,773,425 discloses a collapsible lyophilization container for collecting, processing, freeze drying, storing, reconstituting and utilizing biological and/or pharmaceutical products, in particular blood products. The lyophilization container comprising of a pliable bottom, foldable sidewalls, and a hydrophobic membrane as a top wall. The lyophilization container is provided with a hydrophobic membrane as a top wall that provides a fluid path for vapor but not for liquids while acting as a barrier to bacteria. Further, the lyophilization container is provided with removable means to cover the hydrophobic top wall, said cover rendering said membrane inoperative until said means are removed, thereby protecting the membrane during any processing required before the lyophilization process. The impermeable cover or film is removed before the lyophilization. The document does not describe how the impermeable cover or film is applied to the container after the lyophilization process for sealing it.

In case of flexible bags used for lyophilization of biological products they have a shape which when filled is unsuitable for contacting the lyophilizer resulting in a poor heat transfer and thereby slowing down the process.

The above described containers of the prior art have the drawback that the germ-impermeable and vapour-permeable membrane of the lyophilization container can not be sealed after freeze-drying of the product and therefore said containers can not serve as final storing containers. In case after lyophilization an impermeable cover or film is applied to cover the vapour-permeable membrane a sufficient sealing may not be obtained. The sealing step with such a cover or film is also impracticable.

### SUMMARY OF THE INVENTION

Therefore, the object of the invention was to provide a container for lyophilization of liquid products, which is easy to handle, which provides a suitable shape for heat transfer during the lyophilization process, which provides means for easy handling of opening and closing the membrane area before starting the lyophilization process, and which also provides means for easy and reliable sealing after the lyophilization process. In addition, the object was to provide means for protection of the membrane.

The object is solved by a non-collapsible and non-foldable container 1 for lyophilization of a product 2, said container comprising:
a) a plastic tray 3 comprising a bottom wall 4, a continuous peripheral side wall 5 defining an opening 7, and a continuous circumferential rim which is outwardly bulged 6;
b) a top wall 8 for completely covering said opening 7, which top wall 8 is comprising a membrane which membrane is vapour-permeable and provides a bacterial barrier;
c) a removable impermeable snap-on lid 9 for completely covering said top wall 8 and said membrane.

### BRIEF DESCRIPTION OF THE SEVERAL VIEWS OF THE DRAWINGS

FIG. 1 shows a cross section of an embodiment of the container of the present invention.

FIG. 2 shows the introduction of a liquid product into an embodiment of the container of the present invention.

FIG. 3 shows a partial and enlarged view as cross section of an embodiment of the container of the present invention.

### DETAILED DESCRIPTION OF EMBODIMENTS

The present invention provides a container for lyophilization of (liquid) products, which is easy to handle and which provides a suitable shape for heat transfer during the lyophilization process. Further, the inventive container provides means for easy handling of opening and closing the membrane area before starting the lyophilization process, and also provides means for easy and reliable sealing after the lyophilization process, which means also serve the purpose of protecting the membrane.

The container according to the present invention is used for lyophilization, storing, reconstituting and administration of said product. The container according to the present invention is adapted in that way that it provides the containment for the liquid or lyophilized or reconstituted product for all these steps, since there is no need to transfer the lyophilized product to another container for carrying out a subsequent step.

In a preferred embodiment the product is a biological product, a blood component, plasma, a proteinaceous solution, a proteinaceous composition, factor VIII preparation, a bacterial suspension, a viral suspension or a pharmaceutical composition.

The top wall 8 for completely covering said opening 7 is fixed to the tray, i.e. is fixed to the continuous circumferential rim 6, for completely closing the opening 7 of the tray 3. Preferably, the top wall 8 is fixed onto the top surface of the circumferential rim which is outwardly bulged 6, preferably by welding or an adhesive. In a further preferred embodiment of the invention the top wall 8 is entirely made of the membrane, which means that the membrane is entirely forming the top wall 8 and is fixed onto the top surface of the circumferential rim which is outwardly bulged 6.

According to the invention the said snap-on lid 9 for covering said top wall 8 comprises at least one undercut groove 11 for removably engaging with the circumferential rim which is outwardly bulged 6 of the tray 3. The circumferential rim which is outwardly bulged 6 of the tray 3 engages with, i.e. snap-fits with, the undercut groove 11 of the snap-on lid 9, which is due to the flexibility of the snap-on lid and the tray. The purpose of this snap-on lid is the protection of the membrane during handling, such as transport, storage, sterilization, freezing, freeze-drying. Until freeze-drying is complete, the snap-on lid may be simply put on the top of the tray without engagement of circumferential rim which is outwardly bulged and undercut groove. In this position the membrane is protected and gases are allowed to penetrate, that is steam or sterilizing agents during sterilization and water vapour during lyophilization, respectively. This handling is preferably applied, if the snap-on lid is equipped only with one undercut groove 11. After finishing the lyophilization process the lid is pressed down inside the chamber by moving down the shelves for obtaining a closed position of the snap-on lid 9. In this position the undercut groove 11 of the snap-on lid 9 is engaged with the circumferential rim which is outwardly bulged 6 of the tray 3. In this position the container is ready for irreversible fixation to the container and sealing, for example by welding.

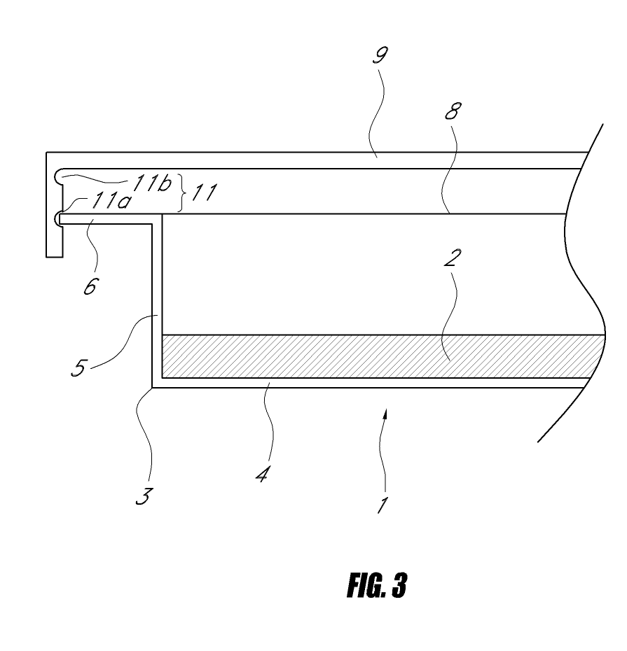

In a preferred embodiment of the invention the snap-on lid 9 comprises two undercut grooves 11a and 11b. The first undercut groove 11a (see for example FIG. 3) is more distant from the surface of the snap-on lid than the second undercut groove 11b. The circumferential rim which is outwardly bulged 6 of the tray 3 can engage, i.e. can snap-fit, with either one of the two undercut grooves 11a and 11b. In case the circumferential rim which is outwardly bulged 6 engages with the first undercut groove 11a the surface of the circumferential rim of the tray does not touch the (lower) surface side of the snap-on lid 9. This position 1 may be used during sterilization of the container and is used during the lyophilization process, because in this position 1 the container 1 is open for the transport of water vapour and gases.

If the circumferential rim which is outwardly bulged 6 in brought into engagement with the second undercut groove 11b the surface of the circumferential rim 6 of the tray is in close contact with the (lower) surface side of the snap-on lid 9. This position 2 is used for closing the container and sealing the opening 7, for example by welding. After sealing the container is closed and not any more open for the transport of water vapour and gases.

Until freeze-drying is complete, the snap-on lid 9 is reversibly fixed in a semi-open position (position 1: i.e. the first undercut groove 11a engages with the circumferential rim which is outwardly bulged 6) protecting the membrane and allowing gases to penetrate, that is steam or sterilizing agents during sterilization and water vapour during lyophilization, respectively. After finishing the lyophilization process the lid is pressed down to position 2 (i.e. the second undercut groove 11b engages with the circumferential rim 6) inside the chamber by moving down the shelves for obtaining a closed position of the snap-on lid. Here the surface of the circumferential rim which is outwardly bulged 6 is in close contact with the (lower) surface side of the snap-on lid 9. In this arrangement the snap-on lid 9 is ready for irreversible fixation to the container 1 and finally sealing the vapour-permeable membrane, preferably by welding.

Therefore, the container preferably is adapted in that way that after lyophilization of the product 2 said snap-on lid 9 and the circumferential rim which is outwardly bulged 6 can be fixed together, preferably by welding, for sealing the opening 7 and the membrane. Any welding process may be applied which is suitable to achieve sealing the opening by fixing the lid to the container. For example, ultrasonic welding, welding by heat or laser welding may be used, preferably ultrasonic welding.

In case laser welding is applied the circumferential rim which is outwardly bulged 6 is coloured with black pigments or dye for welding together the snap-on lid 9 and the circumferential rim which is outwardly bulged 6 by laser welding. Alternatively, the snap-on lid 9 is coloured with black pigments or dye in the area which comes into contact with the circumferential rim which is outwardly bulged 6 for welding together the snap-on lid 9 and the circumferential rim which is outwardly bulged 6 by laser welding. Laser welding is a well-known method. In brief, for welding together two plastic pieces one plastic piece is coloured with black pigment or dye in order to absorb the heat from a laser beam. A laser beam is applied and passing trough the transparent plastic piece until it reaches the black pigmented plastic piece, wherein both are held in close contact. The pigmented plastic piece is absorbing the energy of the laser beam and starting to melt. By this melting and re-solidifying of the plastic material of the pigmented plastic piece, the latter is welded together with the transparent plastic piece.

In a preferred embodiment the side wall 5 of said tray 3 is further comprising one or more port(s) 10 for introduction, reconstituting and administering the product 2. Preferably, the side wall 5 of said tray 3 is comprising at least three ports 10, one for introduction of the (liquid) product 2 to be lyophilized, one for reconstituting the lyophilized product 2, and one for administering the reconstituted product 2. The skilled person understands that when introducing the (liquid) product via the introduction port, that means are applied for closing the other ports in order to avoid leakage.

In a further preferred embodiment the tray 3 is made from polypropylene. Further preferred the vapour-permeable membrane is hydrophobic and preferably made from polypropylene. Still further preferred the snap-on lid is also made from polypropylene. In a further preferred embodiment the polypropylene of which the tray, the membrane or the snap-on lid is made from is free from any additives. The purpose is to prevent the migration of any possible harmful component into the liquid product or the lyophilized product present in the container.

In a further preferred embodiment at least a part of the tray 3 is transparent. The advantage is that each step, introducing the liquid product, lyophilization of the liquid product, storage and reconstitution of the lyophilized product can be checked visually or possibly by optical instruments. This is particularly useful for the reconstitution step.

The present invention also provides a non-collapsible and non-foldable container 1 containing a lyophilized product 2, said container comprising:
a) a plastic tray 3 comprising a bottom wall 4, a continuous peripheral side wall 5 defining an opening 7, and a continuous circumferential rim which is outwardly bulged 6;
b) a top wall 8 for completely covering said opening 7, which top wall 8 is comprising a membrane which membrane is vapour-permeable and provides a bacterial barrier;
c) an impermeable snap-on lid 9 which is covering said top wall 8 and said membrane, and wherein the snap-on lid 9 is engaged with the circumferential rim which is outwardly bulged 6 and wherein the snap-on lid 9 and the circumferential rim which is outwardly bulged 6 are fixed together, preferably by welding, for sealing the opening 7 and the membrane.

In a preferred embodiment the container 1, containing the lyophilized product is sealed in a pouch made of a material which is impermeable for CO₂, O₂ and water vapour, preferably a foil or film made of an aluminum plastic laminate.

In preferred embodiment a further containment is connected to the container 1, preferably via a port 10, which containment is comprising a solution for reconstituting the lyophilized product 2. The further containment advantageously is connected to the container 1 via the reconstitution port by using a tube. Once the lyophilized product is required in its reconstituted form, the sealing means of the reconstitution port are opened or broken and the solution is transferred through the connection tube to the reconstitution port into the container 1, where the solution dissolves the lyophilized product. Once reconstituted, the product is ready for administering. For this purpose the administration port is opened and the reconstituted product is administrated.

In a preferred embodiment the tray 3 comprising bottom wall 4, side walls 5 and circumferential rim which is outwardly bulged 6 is made in one piece by injection molding, and preferably made of polypropylene. Further, preferred the tray 3 is semi-rigid. Even further preferred at least an area of the tray 3 is transparent, further preferred the tray 3 is completely transparent. The vapour-permeable membrane may be made of PTFE (polytetrafluoroethylene). However, a membrane made of polypropylene is preferred, since it is less expensive.

In a particularly preferred embodiment the pore size of the membrane is below 0.45 μm.

The containers of the present invention typically hold from 25 ml to 1000 ml fluid, but preferably hold 50 to 800 ml, further preferred 100 to 500 ml, even further preferred 100 to 300 ml and particularly preferred about 200 ml.

The present invention also provides a method for preparing the container 1 according to any one of claims 1 to 11 having lyophilized product 2 therein, wherein the snap-on lid 9 for covering said top wall 8 comprises one or preferably two undercut groove(s) 11a, 11b for engagement with the circumferential rim which is outwardly bulged 6 of the tray 3, said method comprising the following steps:

a) optionally sterilizing the container 1, preferably by steam sterilization or sterilizing gases;
b) introducing a liquid product 2 into the container 1 via an introduction port 10;
c) sealing the introduction port 10;
d) lyophilizing the liquid product 2, wherein the water vapour is removed via the vapor-permeable membrane arranged in the top wall 8 of said container 1, wherein preferably the snap-on lid 9 comprises two undercut groove(s) 11a, 11b and wherein during the lyophilization step the first undercut groove 11a of the removable snap-on lid 9 is engaged with the circumferential rim which is outwardly bulged 6;
e) welding together snap-on lid 9 and the circumferential rim which is outwardly bulged 6 for sealing said top wall 8 with said impermeable snap-on lid 9, wherein preferably the snap-on lid 9 comprises two undercut groove(s) 11a, 11b and the second undercut groove 11b of the impermeable snap-on lid 9 is engaged with the circumferential rim which is outwardly bulged 6, and;
f) optionally connecting to tray 3a further containment comprising a solution for reconstituting the lyophilized product 2, preferably via reconstituting port 10;
g) optionally sealing the container 1 in a pouch made of a material which is impermeable for CO₂, O₂ and water vapour, preferably a foil or film made of an aluminum plastic laminate.

Preferably, the method is further comprising the following steps:

h) if applicable, opening the pouch;
i) optionally connecting to tray 3a further containment comprising a solution for reconstituting the lyophilized product 2, preferably via reconstituting port 10;
j) bringing together the lyophilized product 2 with the solution for reconstitution;
k) obtaining a reconstituted product 2.

For the sterilization of the container steam sterilization or sterilizing gases such as H₂O₂ or ethylene oxide may be used.

The present invention will be further explained in detail by referring to the figures:

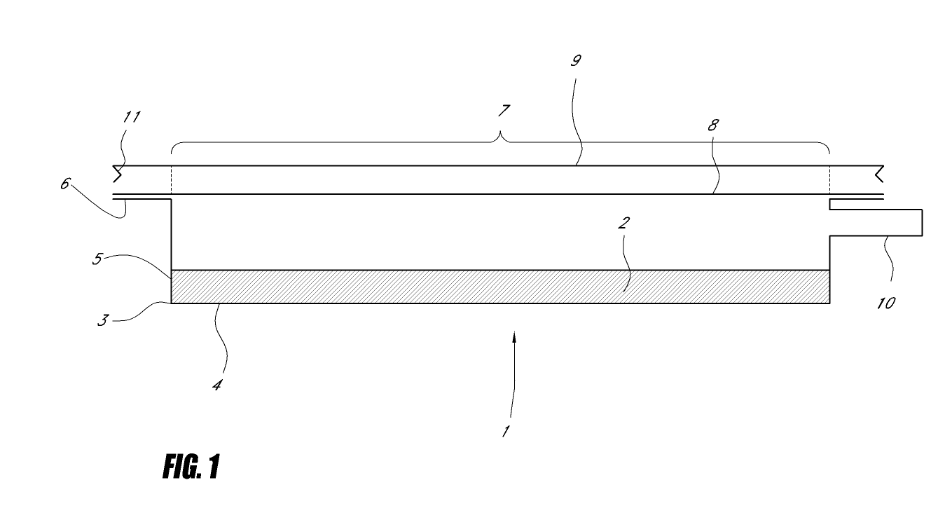

FIG. 1 shows a cross section of the container of the present invention. In this figure the (liquid) product 2 is already introduced into the container 1. The container 1 features a plastic tray 3, made of a bottom wall 4, a continuous peripheral side wall 5 and a continuous circumferential rim which is outwardly bulged 6. The tray as such has an opening 7 which is indicated by the reference sign 7. The tray is preferably made of polypropylene in one piece by injection-moulding. The circumferential rim which is outwardly bulged 6 serves for fixing the top wall including the membrane, or the membrane itself in case the top wall is provided in its entirety by the membrane: in the embodiment shown in this figure the entire top wall 8 is constituted by a vapour-permeable membrane which also provides a bacterial barrier. As shown the membrane is fixed onto the upper surface of the circumferential rim which is outwardly bulged 6. Further, a removable impermeable snap-on lid 9 is provided for complete covering the top wall 8 and protecting said membrane. The snap-on lid comprises an undercut groove 11. The circumferential rim which is outwardly bulged 6 of the tray 3 can engage with, i.e. can snap-fit with, the undercut groove 11 of the snap-on lid 9, which is due to the flexibility of the lid and the tray. The purpose of this snap-on lid is the protection of the membrane during handling. The snap-on lid 9 gives protection to the membrane even without being permanently fixed (welded) to the tray. It should be noted that the snap-on lid 9 is removable even after the snap-on lid 9 is engaged with the circumferential rim which is outwardly bulged 6. In this figure the snap-on lid 9 is not yet engaged with the circumferential rim which is outwardly bulged 6.

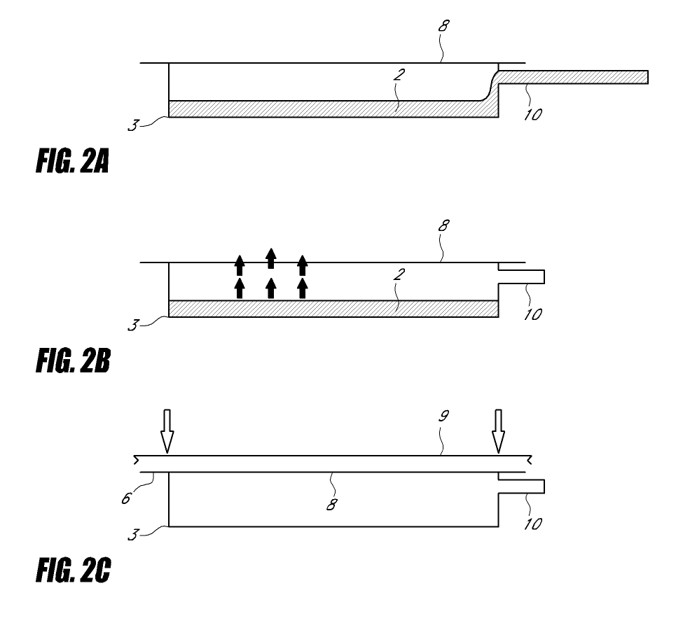

FIG. 2 shows the introduction of a liquid product 2 into the container 1 via a port 10 (panel a). Panel b shows the lyophilisation step, wherein the water vapour (filled arrows) is passing through the vapour permeable membrane representing the top wall 8, which is closing the opening 7. After lyophilisation the snap-on lid 9 is put on top of the tray 3, thereby covering the top wall 8, i.e. the membrane (see panel c). The snap-on lid 9 will engage with the periphery of the circumferential rim which is outwardly bulged 6 of the tray 3. Finally the snap-on lid 9 and the circumferential rim which is outwardly bulged 6 are welded together. In panel c of FIG. 2 the lyophilized product itself is not shown. In panel b and panel c the port 10 is sealed.

FIG. 3 shows a partial and enlarged view as cross section of a further preferred embodiment of the container 1 of the present invention. In this figure the liquid product 2 is already introduced into the container 1. In the embodiment shown the removable impermeable snap-on lid 9 comprises two undercut grooves 11a and 11b. The first undercut groove 11a (position 1) as well as the second undercut groove 11b (position 2) of the snap-on lid 9 can engage with the circumferential rim which is outwardly bulged 6. In the figure the first undercut groove 11a of the snap-on lid 9 is engaged with the circumferential rim which is outwardly bulged 6, so that the snap-on lid is brought into position 1 in relation to the tray 3. The purpose of position 1 of the snap-on lid 9 is to protect the membrane while the inner of the tray is still in communication with the outside through the membrane. In position 1 there is a distance between the upper surface of the circumferential rim which is outwardly bulged 6 and the (lower) surface of the snap-on lid 9. The engagement in position 1 is used for example for the sterilization step before the liquid product is introduced and during lyophilization. After lyophilization the snap-on lid 9 is moved downwards from position 1 to position 2. Here, the second undercut groove 11a of the snap-on lid 9 engages with the circumferential rim which is outwardly bulged 6. In this position 2 the circumferential rim which is outwardly bulged 6 and the surface of the snap-on lid 9 are in close contact and thereby the snap-on lid 9 is ready for being welded to the tray in order to finally seal the opening 7.

### LIST OF REFERENCE SIGNS

1 container
2 product
3 plastic tray
4 bottom wall
5 side walls
6 circumferential rim which is outwardly bulged
7 opening
8 top wall with membrane
9 snap-on lid
10 port(s)
11. undercut groove(s)
   11a first undercut groove, position 1
   11b second undercut groove, position 2

What is claimed is:

1. A non-collapsible and non-foldable container for lyophilization of a product, said container comprising:
a) a plastic tray comprising a bottom wall, a continuous peripheral side wall defining an opening, and a continuous circumferential rim which is outwardly bulged;
b) a top wall for completely covering said opening, which top wall is comprising a membrane which membrane is vapour-permeable and provides a bacterial barrier; and
c) a removable impermeable snap-on lid for completely covering said top wall and said membrane.

2. The container according to claim 1, used for lyophilization, storing, reconstituting and administration of said product.

3. The container according to claim 1, wherein the product is selected from the group consisting of a biological product, a blood component, plasma, a proteinaceous solution, a proteinaceous composition, a factor VIII preparation, a bacterial suspension, a viral suspension or pharmaceutical composition.

4. The container according to claim 1, wherein said snap-on lid for covering said top wall comprises one or two undercut groove(s) for engagement with the circumferential rim which is outwardly bulged of the tray.

5. The container according to claim 4, wherein said snap-on lid for covering said top wall comprises two undercut groove(s), wherein said snap-on lid is removably engaged with the circumferential rim which is outwardly bulged of the tray either with the first or the second undercut groove.

6. The container according to claim 1, wherein after lyophilization of the product said snap-on lid and the circumferential rim which is outwardly bulged can be fixed together, preferably by welding, for sealing the opening and thereby covering the membrane.

7. The container according to claim 1, wherein the side wall of said tray is further comprising one or more port(s) for introduction, reconstituting and administering the product.

8. The container according to claim 1, wherein the side wall of said tray is further comprising at least three ports, one for introduction of the liquid product to be lyophilized, one for reconstituting the lyophilized product, and one for administering the reconstituted product.

9. The container according to claim 1, wherein the tray is made from polypropylene, preferably without any additives.

10. The container according to claim 1, wherein the vapour-permeable membrane is made from polypropylene, preferably without any additives.

11. The container according to claim 1, wherein at least a part of the tray is transparent.

12. A non-collapsible and non-foldable container containing a lyophilized product, said container comprising:
a) a plastic tray comprising a bottom wall, a continuous peripheral side wall defining an opening, and a continuous circumferential rim which is outwardly bulged;
b) a top wall for completely covering said opening, which top wall is comprising a membrane which membrane is vapour-permeable and provides a bacterial barrier; and
c) an impermeable snap-on lid which is covering said top wall and said membrane, and wherein the snap-on lid is engaged with the circumferential rim which is outwardly bulged and wherein the snap-on lid and the circumferential rim which is outwardly bulged are fixed together, preferably by welding, for sealing the opening and the membrane.

13. The container according to claim 12, wherein a further containment is connected to the container, preferably via a port, which containment is comprising a solution for reconstituting the lyophilized product.

14. A method for preparing the container according to claim 1 having lyophilized product therein, wherein the snap-on lid for covering said top wall comprises two undercut grooves for engagement with the circumferential rim which is outwardly bulged of the tray, said method comprising the following steps:
a) optionally sterilizing the container, preferably by steam sterilization or sterilizing gases;
b) introducing a liquid product into the container 1 via an introduction port;
c) sealing the introduction port;
d) lyophilizing the liquid product, wherein the water vapour is removed via the vapor-permeable membrane arranged in the top wall of said container, wherein the snap-on lid comprises two undercut grooves and wherein during the lyophilization step the first undercut groove of the removable snap-on lid is engaged with the circumferential rim which is outwardly bulged;
e) welding together snap-on lid and the circumferential rim which is outwardly bulged for sealing said top wall with said impermeable snap-on lid, wherein the snap-on lid comprises two undercut grooves and the second undercut groove of the impermeable snap-on lid is engaged with the circumferential rim which is outwardly bulged;
f) optionally connecting to tray a further containment comprising a solution for reconstituting the lyophilized product, preferably via reconstituting port; and
g) optionally sealing the container in a pouch made of a material which is impermeable for CO₂, O₂ and water vapour, preferably a foil or film made of an aluminum plastic laminate.

15. The method according to claim 14 for providing reconstituted product, further comprising the following steps:
h) if applicable, opening the pouch;
i) optionally connecting to tray a further containment comprising a solution for reconstituting the lyophilized product, preferably via reconstituting port;
j) bringing together the lyophilized product with the solution for reconstitution; and
k) obtaining a reconstituted product.
